(19) United States
(12) Patent Application Publication
(10) Pub. No.: US 2012/0101848 A1
(43) Pub. Date: Apr. 26, 2012

(54) PORTABLE PERSONAL HEALTH RECORD DATA PROCESSING SYSTEM

(75) Inventors: Shey-Shi Lu, Taipei (TW); Hsiao-Chin Chen, Taipei (TW); Yu-Lun Chang, Taipei (TW); Chen Tsou, Taipei (TW); Bi-Ru Wu, Taipei (TW); Yao-Hung Wang, Taipei (TW); Hung-Wei Chiu, Taipei (TW); Beender Yang, Taipei (TW)

(73) Assignee: NATIONAL TAIWAN UNIVERSITY, Taipei (TW)

(21) Appl. No.: 13/278,505

(22) Filed: Oct. 21, 2011

(30) Foreign Application Priority Data
Oct. 22, 2010 (TW) 99136044

(51) Int. Cl. G06Q 50/24

(52) U.S. Cl. 705/3

(57) ABSTRACT

A personal case history processing system writes health relevant data generated by a medical equipment into a data chip or supplies the health relevant data in the data chip to the medical equipment through a data reading/writing device or directly to the medical equipment by performing transmission of the health relevant data between the data chip and the corresponding data reading/writing device and/or the medical equipment, wherein the data chip may be connected to an IC card or a portable data processing device. Accordingly, personal transmission, reading/writing and access of the health relevant data may be realized.

### BACKGROUND OF THE INVENTION

1. Field of the Invention

The present invention relates to a personal health record data processing system, and, more particularly, to a personal health record data processing system combining a portable data storing device and a measurement equipment device.

2. Description of Related Art

A health record is collection of medical data consisting of all medically relevant records of a patient receiving medical services at one or more hospitals or medical clinics. The source of medical data is basically coming from data representing text, images, symbols, graphics, sound, video, sections, inspection results, and so on formed during the process of medical activities of inquiry, physical inspection, auxiliary inspection, diagnosis, treatment, care, and similar activities by medical staff members, for example, doctors, nurses, medical engineers/technicians, pharmacists, rehabilitation doctors, dieticians and so on.

A health record not only records a patient's condition but also the process of analysis, diagnosis, treatment and care of the patient's condition, as well as estimates of prognosis by doctors and comments from visitation rounds and consultation by doctors at all levels. Thus, the health record is not only an actual record of a patient's condition but also a reflection of the quality of medical treatment and care and academic level.

In the past, hospitals or medical staff members often would not supply a patient's heath record to the patient for various reasons. Even when a patient was transferring to another hospital or had another pressing need for his/her health record, there were few hospitals or medical staff members willing to supply a complete health record of the patient to the patient or another medical institution. This obviously deprives a patient of his or her inherent rights to obtain and use such information as the patient sees best in the process of overseeing his or her own health care. However, nowadays, there are trends towards not only protecting a patient's privacy but also empowering the patient to participate in his or her own health care in an informed manner. As such, many countries have enacted statutes that not only require medical service providers to keep medical records but also make those records accessible to their patients as a matter of course or on demand. For example, in Taiwan, the medical law has been amended to conform with this trend to expressly require that medical institutions should provide copies of patient health records upon request and not delay or refuse granting such requests without due cause. Hence, mobility of patients' health records will be greatly increased.

Along with this trend, advancements in electronics provide the potential to portably and reliably store the various kinds of medical data generated during medical activities. Recently some handheld devices have been developed to exchange health relevant data or records with only one type of medical equipment. However, patients need a device or a system that can exchange health relevant data or records with at least two types of medical equipments. If available, such electronic health records could assist patients in obtaining, copying, carrying and using their health records, which could lengthen patients' lives and improve their quality of life.

As such, it is critically important to find a way to enable patients to obtain, copy, carry and use electronic health records more efficiently.

### SUMMARY OF THE INVENTION

In view of the above-mentioned problems of the prior art, the present invention provides a portable personal health record data processing system comprising a data chip and a data reading/writing device, wherein the data chip is used to store personal health data, and the data reading/writing device writes the personal health data to the data chip and reads the personal health data from the data chip, and wherein the data reading/writing device is communicable to at least two different types of medical equipments and to exchange the personal health data with the medical equipments.

Additionally, the present invention further provides a personal health record data processing system comprising a portable data processing device, having a first data chip connected to the portable data processing device to communicate with a medical equipment generating personal health data, wherein a second data chip is connected to the medical equipment for exchanging the personal health data with the first data chip. The first data chip is actuated by the portable data processing device to selectively transmit an activate or wake-up signal to the second data chip, to actuate the second data chip to transmit the personal health data generated by the medical equipment device to the first data chip.

In an embodiment of the present invention, the first data chip, after receiving the personal health data transmitted by the second data chip, further transmits a shut down or sleep signal to the second data chip, to stop exchanging with the second data chip.

In another embodiment of the present invention, the first data chip further transmits identity data to the second data chip after the second data chip is activated, while the second data chip supplies the received identity data for the medical equipment device so as to perform identity confirmation.

In a further embodiment of the present invention, the second data chip further transmits the measured data and the identity data generated by the medical equipment device to the first data chip, and the first data chip, after receiving the measured data and the identity data transmitted by the second data chip, further transmits a shut down or sleep signal to the second data chip, to stop exchanging with the second data chip.

Compared to the prior art, the personal health record data processing system of the present invention writes the measured data generated by at least two different types of medical equipments into the data chip or supplies the health record data in the data chip to the medical equipments through the data reading/writing device or directly to the medical equipments by performing transmission of the health record data between the data chip and the corresponding data reading/writing device and/or the medical equipments, wherein the data chip may be further connected to an IC card or the portable data processing device. Accordingly, the effect of personal transmission, reading/writing and access of the health relevant data may be realized.

### BRIEF DESCRIPTION OF DRAWINGS

FIG. 1 provides an application architecture diagram of a personal health record data processing system in accordance with an implementation aspect of the present invention; and

FIG. 2 provides an application architecture diagram of the personal health record data processing system in accordance with another implementation aspect of the present invention.

### DETAILED DESCRIPTION OF PREFERRED EMBODIMENTS

The following illustrative embodiments are provided to illustrate the disclosure of the present invention and its advantages, these and other advantages and effects being readily understood by those skilled in the art after reading the disclosure of this specification. The disclosure can also be performed or applied by other embodiments. The details of the specification may be on the basis of specific points and applications, and numerous modifications and variations can be devised without departing from the spirit of the disclosure.

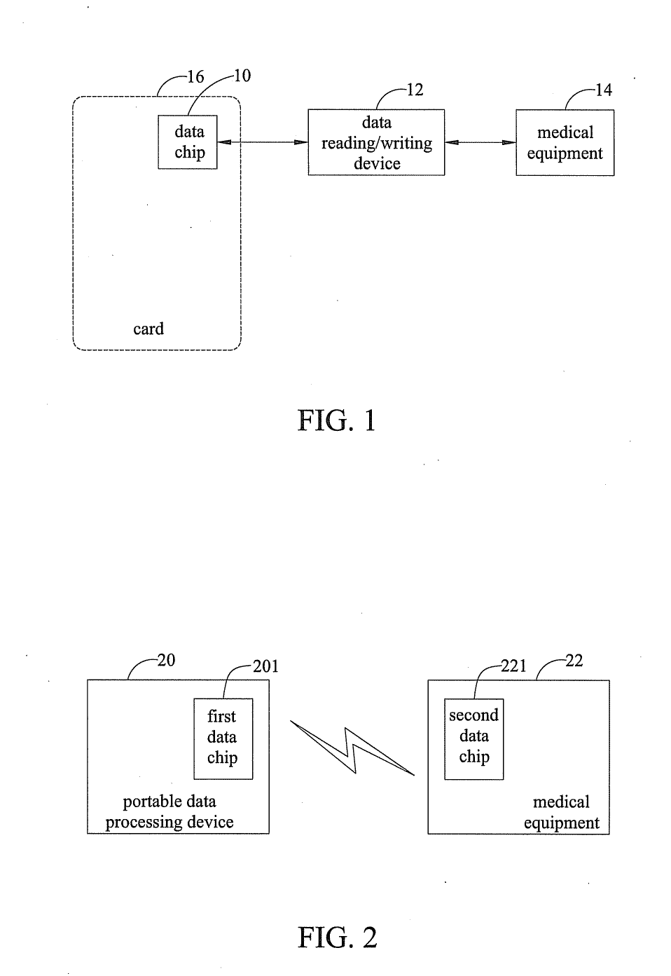

Referring to FIG. 1, the present invention relates to a personal health record data processing system comprising a data chip 10 and a data reading/writing device 12. The data chip 10 is used to store health relevant data and used to write and/or read the health relevant data with respect to the data chip 10 through the data reading/writing device 12. In the implementation aspect, the data chip 10 may be a IC card chip or an intelligent card chip, and the data chip 10 being a IC card chip or an intelligent card chip may be combined with a card 16, for example, a health insurance card, an so-called easy card (such as a metro card) or an identity card.

Said health relevant data comprise data for text, images, symbols, graphics, sound, video and so on formed during the process of medical activities, such as inquiry, measurement, inspection, diagnosis, treatment, care, rehabilitation, by doctors, nurses, medical engineers/technicians, pharmacists, rehabilitation doctors, dieticians and so on. Said health relevant data may be processed, transmitted and/or stored in the form of electromagnetic records and presented through a data processing device, for example, a computer or an intelligent mobile device, such as a smart phone.

For example, the health relevant data may be a diagnosis, doctor's advice or a prescription input by a health record producing application program through a computer during a doctor inquiry process. Moreover, the health relevant data may be data representing text, images, symbols, graphics, sound, video, etc., generated after executing functions of measurement, inspection, diagnosis, treatment, care, rehabilitation and the like by using, for example, electronic height-weight meters, X-ray machines, CT scanners, ultra-sonic scanners, SPO2 (blood oxygen) meters, electronic glucose meters, electronic blood pressure meters or electrocardiogram machines.

The data reading/writing device 12 is a chip data reading/writing device corresponding to the data chip 10. As previously descried, if the data chip 10 is combined with a health insurance card, easy transaction card or an identity card, then the data reading/writing device 12 may be a reading/writing device corresponding to the card 16, for example, the aforementioned health insurance, easy transaction or identity cards, performing health relevant data writing and/or reading with respect to the IC card chip or the smart card chip.

The data reading/writing device 12 may be further used to mutually communicate with at least two types of medical equipments 14 and to perform transmission of health relevant data with the medical equipments 14. In another implementation aspect, the data reading/writing device 12 may be mutually communicated to the medical equipments 14 through a wired and/or wireless way and perform transmission of the health relevant data with the medical equipments 14 through said wired and/or wireless way.

The medical equipments 14 may be the previously-described data processing device for doctors and other medical staff to input the health relevant data or may be the previously described electronic height-weight meters, X-ray machines, CT scanners, ultra-sonic scanners, SPO2 (blood oxygen) meters, electronic glucose meters, electronic blood pressure meters, electrocardiogram machines and like medical equipments.

Said data reading/writing device 12 may be further used to write the health relevant data received from the medical equipments 14 into the data chip 10 and/or transmit the health relevant data read from the data chip 10 to the medical equipments 14. That is to say, the health relevant data may be written into the data chip 10 through the data reading/writing device 12 so as to be stored in the data chip 10 after the medical equipments 14 performs measurement, diagnosis, inspection or treatment. On the other hand, if the medical equipments 14 needs the health relevant data previously stored in the data chip 10 for reference for measurement, diagnosis, inspection or treatment, then the health relevant data stored in the data chip 10 may be transmitted to the medical equipments 14 after being read through the data reading/writing device 12.

In another embodiment, the data reading/writing device 12, when read the health relevant data from the data chip 10 or writing the health relevant data to the data chip 10, wirelessly charges the data chip 10 simultaneously, which may be achieved by magnetically induced currents. According to the present invention, the data chip 10 does not need a battery or a power supply module. The data reading/writing device 12, when reading the health relevant data from the data chip 10 or writing the health relevant data to the data chip 10, may charge the data chip 10 wirelessly (e.g., magnetically induced currents). For instance, if the data chip 10 is implanted in the subcutaneous tissue, and the data chip 10 cannot be charged through a wired route. The data chip 10, when not in use, is operating in a sleep mode. When needing to read the health relevant data from the data chip 10 or writes the health relevant data to the data chip 10, a user may move the data reading/writing device 12 close, but in no contact with, the data chip 10 in order to charge the data chip 10. Therefore, the data chip 10 does not need a battery or a power supply module installed.

It should be noted that said data chip 10 performing one-way or two-way health relevant data transmission regime with the medical equipments 14 through the data reading/writing device 12, the application aspect of the data chip 10, the cooperation of the data chip 10 and the card 16, and the wired or wireless way adopted between the data reading/writing device 12 and the medical equipments 14 all may be adjusted according to actual requirements and implementations are not limited to only those embracing all of these technical means.

Referring to FIG. 2, an application architecture diagram of the personal health record data processing system in accordance with another embodiment of the present invention is shown. In the embodiment, the personal health record data processing system of the present invention comprises a portable data processing device 20 which is used to communicate with at least two different types of medical equipments 22.

The portable data processing device 20 may be a mobile phone having data processing ability that has a first data chip 201. The first data chip 201 may be internally built into the portable data processing device 20, for example, in the form of an integrated chip attached to a PC board. Alternatively, the first data chip 201 may be externally connected to the portable data processing device 20 through a wired way, for example, USB transmission, or through a wireless communication way, for example, IR, Bluetooth, Xbee, WiFi and so on.

When the first data chip 201 is internally built in to the portable processing device 20, the first data chip 201 may receive power supplied by the portable data processing device 20 or receive power externally from a power supply. Alternatively, the first data chip 201 may have an independent power source when externally connected to the portable data processing device 20, for example, a battery.

The medical equipment 22 may be a data processing device or a medical equipment device being the same with or similar to that of the previously described medical equipments 14, wherein the medical equipment 22 has a second data chip 221 for communicating with the first data chip 201 and performing transmission of the health relevant data with the first data chip 201. The second data chip 221 communicates with the first data chip 201 and performs transmission of the health relevant data with the first data chip 201 through the wireless way. The wireless way may be wireless transmission technique meeting wireless communication standards of, for example, an IR technique or an RF technique (e.g., Xbee, Bluetooth, RFID, WiFi or other IEEE 802.X standards).

Said first data chip 201 may be activated by the portable data processing device 20, that is, the first data chip 201 may be activated through software or hardware internally built inside the portable data processing device 20. For example, if clicking a personal health relevant application program internally built inside the portable data processing device 20, the first data chip 201 may be activated, but it is not limited to this method.

After activation, the first data chip 201 transmits an activation and/or wake-up signal to the second data chip 221 such that the second data chip 221 may be activated and transmits the health relevant data generated by the medical equipment 22 to the first data chip 201. In an implementation aspect, after activation, the first data chip 201 transmits not only said activate and/or wake-up signal but also identity data to the second data chip 221, while the second data chip 221 supplies the received identity data to the medical equipment 22 so as to perform identity confirmation. In the implementation aspect of the previously described portable data processing device 20 being a mobile phone, the identity data may be a SIM card number of the portable data processing device 20 or a MAC address uniquely belonging to the portable data processing device 20, but it is not limited to these examples. Any data which can identify the user identity of the portable data processing device 20 may act as said identity data.

In an implementation aspect, the first data chip 201 is further used to transmit a shut down or sleep signal to the second data chip 221 so as to end communication and data transmission with the second data chip 221 after completing reception of the health relevant data supplied by the second data chip 221. Accordingly, this aspect may achieve the effect of distinguishing different users coming before or after in a multi-user environment. It may also avoid disturbance possibly generated in an environment of using a plurality of first data chips 201 and second data chips 221 or reduce the risk of improper disclosure of the case history data. Of course, this aspect may also decrease power consumption of the medical equipment 22 when the second data chip 221 receives the shut down or sleep signal and then quickly shuts down operation or enters a sleeps status.

As previously described, if combining the implementation aspect of the first data chip 201 transmitting the identity data to the second data chip 221 with the implementation aspect of the first data chip 201 transmitting the shut down or sleep signal to the second data chip 221, then, prior to being instructed to shut down/sleep, the second data chip 221 may be further used to transmit the health relevant data generated by the medical equipment 22 and the previously received identity data to the first data chip 201. After which, the first data chip 201 may be further used to transmit said shut down or sleep signal to the second data chip 221 so as to end mutual communication and data transmission with the second data chip 221 after completing reception of the case history data and the identity data transmitted by the second data chip 221.

In another implementation aspect, the second data chip 221 may be further used to directly drive the operation of the medical equipment 22 after receiving the activate and/or wake-up signal transmitted by the first data chip 201 and then being activated. Accordingly, the user may directly perform operation of the medical equipment 22 without additionally activating the medical equipment 22.

It should be noted that different technical means of the connection form of said first data chip 201 and the portable data processing device 20, the transmission form of the data and/or the identity data between the first data chip 201 and the second data chip 221, the form of the identity data, the corresponding actuation form of the first data chip 201 transmitting the activate and/or wake-up signal to the second data chip 221, the corresponding actuation form of the first data chip 201 transmitting the shut down or sleep signal to the second data chip 221 and so on all may be regulated or adjusted according to actual requirements and implementation aspects are not limited to those embracing all of these technical means.

In conclusion, the personal health record data processing system of the present invention writes the health relevant data generated by the medical equipment into the data chip or supplies the health relevant data in the data chip to the medical equipment through the data reading/writing device or directly to the medical equipment by performing transmission of the health relevant data between the data chip and the corresponding data reading/writing device and/or the medical equipment, wherein the data chip may be further connected to an IC card or the portable data processing device. Accordingly, the effect of personal transmission, reading/writing and access of the health relevant data may be realized.

The foregoing implementation aspects exemplarily provide the principles and functions of the present invention and are not to be considered restrictive of the scope of the present invention. One skilled in the art could modify and vary the previous implementation aspects without violating the spirit and scope of the present invention. The actual protective scope of the present invention falls within the scope of the appended claims.

What is claimed is:

1. A personal health record data processing system, comprising:
a data chip; and
a data reading/writing device,
wherein the data chip is used to store health relevant data, and the data reading/writing device reads the health relevant data from the data chip and writes the health relevant data to the data chip, and
wherein the data reading/writing device is communicable to at least two different types of medical equipments and to exchange the health relevant data with said medical equipments.

2. The personal health record data processing system of claim 1, wherein the data reading/writing device further writes the health relevant data received from at least one of the medical equipments into the data chip and transmits the health relevant data read from the data chip to the at least one of the medical equipments.

3. The personal health record data processing system of claim 1, wherein the data reading/writing device communicates with the medical equipments through a wired or wireless way and exchanges the health relevant data with the medical equipments through the wired or wireless way.

4. The personal health record data processing system of claim 1, wherein the data chip is an IC card chip or an intelligent card chip.

5. The personal health record data processing system of claim 1, wherein the data chip is an IC card chip or an intelligent card chip combined with a health insurance card, an easy transaction card or an identity card.

6. The personal health record data processing system of claim 1, wherein the data reading/writing device, when reading the health relevant data from the data chip or writing the health relevant data to the data chip, wirelessly charges the data chip simultaneously.

7. A personal health record data processing system, comprising:
a portable data processing device;
a first data chip connected to the portable data processing device for communication with at least two different types of medical equipments generating health relevant data; and
a second data chip connected to the medical equipments for exchanging the health data with the first data chip, wherein the first data chip is actuated by the portable data processing device to selectively transmit an activate or wake-up signal to the second data chip, so as to actuate the second data chip to transmit the health relevant data generated by the medical equipments to the first data chip.

8. The personal health record data processing system of claim 7, wherein the first data chip, after having received the health relevant data transmitted from the second data chip, further transmits a shut down or sleep signal to the second data chip, so as to stop exchanging with the second data chip.

9. The personal health record data processing system of claim 7, wherein the first data chip, after the second data chip is activated, further transmits identity data to the second data chip, while the second data chip supplies the received identity data for the medical equipments so as to perform identity confirmation.

10. The personal health record data processing system of claim 9, wherein the second data chip further transmits the health relevant data and the identity data generated by the medical equipments to the first data chip, and wherein the first data chip, after having received the health relevant data and the identity data transmitted from the second data chip, further transmits a shut down or sleep signal to the second data chip, so as to stop exchanging with the second data chip.

11. The personal health record data processing system of claim 7, wherein the portable data processing device is a mobile phone.

12. The personal health record data processing system of claim 11, wherein the first data chip, after the second data chip is activated, further transmits identity data to the second data chip, while the second data chip supplies the received identity data for the medical equipments so as to perform identity confirmation, the identity data being a SIM card number or a MAC address of the mobile phone.

13. The personal health record data processing system of claim 7, wherein the first data chip exchanges the health relevant data with the second data chip wirelessly.

14. The personal health record data processing system of claim 13, wherein the first data chip exchanges the health relevant data with the second data chip in an RF, infrared ray, Bluetooth or IEEE 802.X communication standard.

15. The personal health record data processing system of claim 7, wherein the first data chip is externally connected to the portable data processing device.

16. The personal health record data processing system of claim 7, wherein the second data chip is externally connected to the medical equipments.

17. The personal health record data processing system of claim 7, wherein the first data chip receives working power supplied by the portable data processing device.

18. The personal health record data processing system of claim 7, wherein the second data chip receives working power supplied by the medical equipments.

19. The personal health record data processing system of claim 7, wherein the second data chip, after having received the activate or wake-up signal and then having been activated, further directly drives operation of the medical equipments.

20. A portable data processing assembly that communicates with at least two different types of medical equipments that generate health relevant data and connected to a second data chip, the portable data processing assembly comprising:
a portable data processing device; and
a first data chip connected to the portable data processing device and actuated by the portable data processing device to selectively transmit an activate or wake-up signal to the second data chip, so as to actuate the second data chip to transmit the health relevant data to the first data chip.
